(19) United States
(12) Patent Application Publication
(10) Pub. No.: US 2006/0188940 A1
(43) Pub. Date: Aug. 24, 2006

(54) Combinatorial hydrogel formulation

(76) Inventors: Michael Cima, Winchester, MA (US); Sherri Colvin, Belmont, MA (US); Colin R. Gardner, Concord, MA (US); Javier Gonzalez-Zugasti, N. Billerica, MA (US); J. Richard Gyory, Sudbury, MA (US); Wendy Pryce-Lewis, Lexington, MA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/358,326

(22) Filed: Feb. 21, 2006

Related U.S. Application Data
(60) Provisional application No. 60/655,045, filed on Feb. 22, 2005.

(51) Int. Cl. C40B 40/02

(52) U.S. Cl. 435/7.1

(57) ABSTRACT

The present invention concerns a method, apparatus (array assembly), and system for fabricating and formulating hydrogels using combinatorial techniques; a hydrogel array fabricated using the method, apparatus, and/or system of the invention; and methods and systems for testing the properties of arrayed hydrogels, such as bulk and interfacial mechanical properties.

### BACKGROUND OF THE INVENTION

A gel is a state of matter that is intermediate between solids and liquids, and which consists of a solvent inside a three dimensional network. Gels containing water (hereinafter, referred to as hydrogels) are important materials for living organisms and are used in the diverse fields of pharmaceuticals, medical care, foods, cosmetics, agriculture, packaging, sanitary goods, and civil engineering (Yoshihisa Nagata and Kanji Kajiwara, “Gel Handbook”, 2000, Academic Press, New York).

Hydrogels are a class of polymeric material that typically has soft and rubbery-like consistency and low interfacial tension (Kudela V., Hydrogels, In: Jacquiline I. K., eds., Encyclopedia of Polymer Science and Engineering, p. 783-807, 1976). Hydrogels absorb solvents such as water, undergo rapid swelling without discernible dissolution, and maintain three-dimensional networks capable of reversible deformation (see, e.g., Park, et al., Biodegradable Hydrogels for Drug Delivery, Technomic Pub. Co., Lancaster, Pa. (1993)). Their surface properties, perme-selectivity, and permeability bear similarity to those of living tissue and, thus, are particularly useful for biomedical applications, having some advantages in relation to other polymeric biomaterials. The nature of the hydrogel structure, due to its high water content, allows the extraction of the undesirable reaction by-products before implantation and the flow of body fluids between the tissue and implant in vivo. A number of aqueous hydrogels have been used in various biomedical applications, such as soft contact lenses, wound management, and drug delivery. Optically transparent hydrogels have been used for the fabrication of soft contact lenses (Chirila T. V., J. Biomater. Appl., 1993, 8(2):106-145).

One of the most important aspects of tissue engineering is the design of the scaffold providing the mechanical strength and access to nutrients for the new tissue. Hydrogels have shown great promise as a scaffold for tissue engineering due to their tissue-like water contents, the capability to be formed in situ for ease in implantation, and the ability to encapsulate cells as they cross-link. For customized tissue engineering, it is essential to be able to fabricate three-dimensional scaffolds of various geometric shapes, in order to repair defects caused by accidents, surgery, or birth. Rapid prototyping or solid free-form fabrication (SFF) techniques hold great promise for designing three-dimensional customized scaffolds, although traditional cell-seeding techniques may not provide enough cell mass for larger constructs. The physical and biological properties of the hydrogel scaffold play an important role in the development of engineered tissues. High-density tissue constructs have been fabricated using photopolymerizable hydrogels and cell encapsulation methods (Dhariwala B. et al., Tissue Engineering, 2004, 10(9-10): 1316-1322). A porous hydrogel can be used as a sponge biomaterial such as a synthetic graft for the repair of cartilaginous, osseous, and other tissues (Chirila T. V. et al., Biomaterials, 1993, 14(1):26-38; Kon M. et al., Plast. Recontr. Surg., 67(3):288-294). Enhanced cartilage tissue development has been demonstrated using hydrogels that were degradable and had an increased pore size (Bryant S. J. et al., BiomedSci. Instrum., 1999, 35:309-314; Bryant S. J. et al., Biomaterials, 2001, 22(6):619-626). Generally, a hydrogel scaffold should initially be strong to survive the in vivo environment and protect encapsulated cells and nascent tissue while eventually degrading to increase pore size and allow for fully functional tissue formation. The addition of degradable linkages in photo-polymerizing gels has been investigated (Anseth K. S. et al., J. Control Release, 2002, 78(1-3):199-209; Nuttelman C. R. et al., Biomaterials, 2002, 23(17):3617-3626; Halstenberg S. et al., Biomacromolecules, 2002, 3(4):710-723; Tirelli N. et al., J. Biotechol., 2002, 90(1):3-15; Cruise G. M. et al., Biomaterials, 1998, 19(14):1287-1294; Cruise G. M. et al., Cell Transplant, 1999, 8(3):293-306).

Hydrogels are water-swollen networks of hydrophilic homopolymers or copolymers. These networks may be formed by various techniques; however, the most common synthetic route is the free radical polymerization of vinyl monomers in the presence of a difunctional cross-linking agent and a swelling agent. The resulting polymer exhibits both liquid-like properties, attributable to the major constituent, water, and solid-like properties due to the network formed by the cross-linking reaction. These solid-like properties take the form of a shear modulus that is evident upon deformation.

Hydrogels may be cross-linked or non-cross-linked, however. Non-cross-linked hydrogels are able to absorb water but do not dissolve due to the presence of hydrophobic and hydrophilic regions. A number of investigators have explored the concept of combining hydrophilic and hydrophobic polymeric components in block (Okano, et al., “Effect of hydrophilic and hydrophobic microdomains on mode of interaction between block polymer and blood platelets”, J. Biomed. Mat. Research, 15:393-402 (1981), or graft copolymeric structures (Onishi, et al., in Contemporary Topics in Polymer Science, (Bailey & Tsuruta, Eds.), Plenum Pub. Co., New York, 1984, p. 149), and blends (Shah, “Novel two-phase polymer system,” Polymer, 28:1212-1216 (1987) and U.S. Pat. No. 4,369,229 to Shah) to form the “hydrophobic-hydrophilic” domain systems, which are suited for thermoplastic processing (see, Shah, Chap. 30, in Water Soluble Polymers (Shalaby et al., Eds.), Vol. 467, ACS-Symp. Ser., Amer. Chem. Soc., Washington (1991)). These non-cross-linked materials can form hydrogels when placed in an aqueous environment.

Hydrogels may be formed by physical or chemical cross-linking, or a combination of these two processes. Physical cross-linking takes place as a result of ionic linkages, hydrogen bonding, van der Waals forces, or other such physical forces. Chemical cross-linking occurs due to the formation of covalent linkages. Covalently cross-linked networks of hydrophilic polymers, including water-soluble polymers are traditionally denoted as hydrogels (or aquagels) in the hydrated state. Hydrogels have been prepared based on cross-linked polymeric chains of methoxypoly(ethylene glycol) monomethacrylate having variable lengths of the polyoxyethylene side chains, and their interaction with blood components has been studied (Nagaoka et al., in Polymers as Biomaterial (Shalaby et al., Eds.) Plenum Press, 1983, p. 381).

If an ionic or hydrophobic monomer is incorporated into the hydrogel network, a responsive polymer is often created. This responsiveness takes the form of a volume phase transition, which is characterized by a sudden change in the degree of swelling upon a small change in environmental conditions. This behavior follows the trends seen in linear polymer systems showing response to environmental pH, salt concentrations, and temperature. For example, it is well known that poly(isopropylacrylamide) contains a lower critical solution temperature (LCST) at 34° C. Likewise, isopropylacrylamide hydrogels undergo a discrete collapse of the polymer network at 32 degrees C. Discrete changes in swelling behavior may also be seen in hydrogels incorporating a monomer containing a carboxylic acid moiety. Therefore, with changes in pH, the hydrogel's charge density will change and thus, the swelling behavior of the gel. By changing the amount of water associated with the network, one is effectively changing the hydrophilic/hydrophobic balance and, therefore, one may utilize these systems to reversibly interact with hydrophobic materials.

Hydrogels offer excellent biocompatibility and have been shown to have reduced tendency for inducing thrombosis, encrustation and inflammation when used in medical devices. Unfortunately, the use of hydrogels in biomedical device applications has been hindered by poor mechanical performance. Many medical devices use hydrogels to improve device biocompatibility; however, many hydrogels can only be used in coatings as a result of insufficient mechanical performance for use as a bulk polymer. Many hydrogels suffer from low modulus, low yield stress, and low strength when compared to non-swollen polymer systems. Lower mechanical properties result from the swollen nature of hydrogels and the non-stress bearing nature of the swelling agent.

There remains a need for medical devices comprising hydrogels that can withstand aggressive physician handling without damage, sustain higher stresses encountered during implantation or insertion without inelastic deformation while retaining the original hydrogel properties in vivo.

The possibility of fabrication in various geometric forms and the easy alteration of its physical form allow the adjustment of the physical properties of hydrogels according to a specific application. Generally, the physical characteristics of hydrogels are determined by the synthesis methods and parameters utilized. In order to expand the availability of useful hydrogels, the provision of new types of hydrogels that exhibit superior properties such as homogeneity, transparency, improved dynamic and mechanical properties, and enhanced absorption (e.g., water absorption) is being investigated.

In recent years, chemical discovery has seen an explosion of new science, such as genomics, proteomic and bioinformatics, as well as high-throughput technologies for identifying and/or creating new compounds or chemical entities, such as combinational chemistry. Such technologies allow the researcher to rapidly synthesize and/or identify large numbers of compounds. At the same time, these technologies have led to the development of more compounds that are larger and more hydrophobic, and thus more challenging to develop into products.

Conducting large numbers of experiments results in the need to inspect or otherwise analyze hundreds or thousands of samples, e.g., for the presence of the desired result. And, a large number of the pre-selected samples require continuing analysis. The resulting voluminous data must then be processed effectively and efficiently, e.g., within a reasonable amount of time.

High-throughput technologies, when possible, enable the discovery of various formulations, some of which may be particularly useful as pharmaceuticals, for formulating pharmaceuticals, intermediates for manufacturing drugs, foods, food additives, and the like. (See, e.g., International Application Nos. WO00/59627, WO01/09391, and WO01/51919). Such technologies can result in extraordinary numbers of experiments being conducted very rapidly, thereby creating large amounts of data and results that must be reviewed and analyzed by the scientist in order to identify a desired formulation. For example, in order to discover various formulations, often thousands of experiments, using many different conditions, solvents, additives, pH, thermal cycles, and the like must be conducted. Dozens or even hundreds of variants of the formulation must be analyzed before a desired variant can be identified and chosen for further development as a potential product.

Some devices for facilitating large numbers of experiments simultaneously are known. In addition, there are systems consisting of blocks with multiple wells for performing reactions for different applications such as combinatorial chemistry. Examples of such systems include the TITAN Reactor Clamp and TITAN PTFE MicroPlates (both available from Radleys, Shire Hill, Saffron Walden, Essex CBII 3AZ, United Kingdom). A multiple-well tray for crystallization reactions is described in U.S. Pat. No. 6,039,804. There also exist systems of block, tubes, and seals, such as the Radleys TITAN Glass Micro Reactor Tube System and the WebSeal System (available from Radleys, Shire Hill, Saffron Walden, Essex CBII 3AZ, United Kingdom). Many tubes or vials of different geometries also exist, including many with crimp, threaded, or snap-on caps.

Spectroscopic techniques such as infrared (IR) and Raman spectroscopy are useful for detecting changes in the chemical composition of a hydrogel. In addition, techniques such as high performance liquid chromatography (HPLC), nuclear magnetic resonance (NMR), differential scanning calorimetry, ultra-violet (UV) spectroscopy, circular dichroism (CD), linear dichroism (LD), and X-ray diffraction (XRD) are powerful techniques. However, each of these techniques must be coupled with data analysis and handling techniques to enable data collection and processing of hundred or thousands of samples. All these techniques are not easily adaptable for high-throughput analysis of structural information and order. Indeed, high-throughput analysis still remains a challenge due to the high degree of automation desired in both physical sample handling and in analysis of the collected data. These and many other difficulties are overcome by the systems, apparatuses, and methods disclosed herein. The invention disclosed herein further extends the reach of high-throughput analysis to hydrogel formulations, with a high degree of sensitivity and specificity. Moreover, the disclosed techniques also efficiently use limited test material quantities to enable effective screening of hydrogels at a low cost.

### BRIEF SUMMARY OF THE INVENTION

The present invention concerns a method, apparatus (array assembly), and system for fabricating and formulating hydrogels using combinatorial techniques; a hydrogel array fabricated using the method, apparatus, and/or system of the invention; and methods and systems for testing the properties of arrayed hydrogels, such as bulk and interfacial mechanical properties.

The invention provides methods and systems for systematic analysis, optimization, selection, or discovery of novel or otherwise beneficial hydrogels (e.g., beneficial hydrogels having desired properties, such as improved delivery or processing characteristics, or the ability to confer improved stability, bioavailability, or solubility to bioactive agents carried by the hydrogels) and conditions for formation thereof. In one aspect, the invention includes a method for fabricating and formulating hydrogels using combinatorial methods both in the presence of tissue and in surrogate wells, plates, or molds. In another aspect, the invention includes an array assembly for fabricating arrays of hydrogels.

In other aspects, the invention includes a method and system for testing properties of hydrogels, such as bulk and interfacial mechanical properties of hydrogels.

In another aspect, the invention includes hydrogel arrays, each comprising two or more hydrogel samples, for example, about 9, 12, 24, 48, 96, 384, to hundreds, thousands, ten thousands, to hundreds of thousands or more hydrogel samples.

Using the methods, apparatus, and systems of the invention, many formulations of hydrogels can be characterized in a short period of time. The number of hydrogel precursor solutions can be large and broad in composition. Parallel experiments can be conducted and formulation optimization can be achieved, as well as co-optimization of different aspects simultaneously and quickly, such as swelling capacity, adhesive strength, bulk mechanical properties, drug elution rate, protein adsorption, etc.

Hydrogels that are fabricated, formulated, and characterized using the methods and apparatuses of the invention are potentially useful as biomaterials, transdermal materials, coatings, and other classes of materials.

### BRIEF DESCRIPTION OF THE DRAWINGS

FIGS. 1A and 1B show a 96-well hydrogel array assembly in an assembled view (FIG. 1A) and an exploded view (FIG. 1B), including: base plate 10, tissue 20 (such as skin), mold plate 30 (e.g., TEFLON mold plate), cover plate 40, and fasteners 50 (only one shown in FIG. 1B).

FIG. 2 is a graph showing the force over time during compression. The two formulations have different compressibility.

FIG. 3 is a graph showing the force over time during tensile elongation and adhesive failure from the surface of the tissue. Again, the two formulations display differences in tensile compliance and adhesive strength due to their differing compositions. Shown for N=2.

FIGS. 4A and 4B are graphs of varying ratios of GA and nVP monomers during compression and bonding (FIG. 4A) and during tensile pulling and de-bonding (FIG. 4B).

FIG. 5 is a graph demonstrating that adhesive bond strength is a non-linear function of composition.

### DETAILED DESCRIPTION OF THE INVENTION

The present invention concerns a method, apparatus (array assembly), and system for fabricating and formulating hydrogels using combinatorial techniques; a hydrogel array fabricated using the method, apparatus, and/or system of the invention; and methods and systems for testing the properties of arrayed hydrogels, such as bulk and interfacial mechanical properties of arrayed hydrogels.

Array Assembly

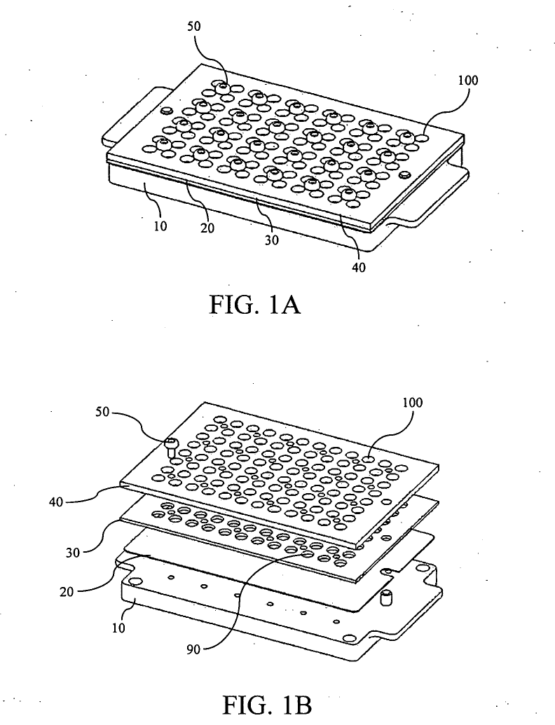

One aspect of the invention is an array assembly for fabricating arrays of hydrogels. The array assembly of the invention includes a base plate 10, mold plate 30, cover plate 40, and optionally tissue 20 and means for fastening the aforementioned components, such as fastener(s) 50 (See FIG. 1B). The base plate 10 is a planar substrate, such as a flat plate. The mold plate 30 and cover plate 40 both have a plurality of holes 90, 100, respectively. At least some of the holes 90, 100 of the mold plate 30 and cover plate 40 are aligned such that, when brought into close contact (into an assembled configuration), the holes 90, 100 of the mold plate 30 and cover plate 40 cooperate with the base plate 10 or (optionally) tissue 20 to form a container for receiving a hydrogel precursor solution to be polymerized or cured. There may be any number of holes 90, 100 and thus any number of containers such as, for example, 9, 12, 24, 48, 96, 384, to hundreds, thousands, ten thousands, to hundreds of thousands. Optionally, the holes 90, 100 are arrayed in an ordered pattern (such as equally spaced rows and columns) in order to facilitate the collection, organization, and analysis of experimental data regarding each hydrogel sample formed in each container.

FIGS. 1A and 1B show a 96-well hydrogel array assembly in an assembled view and exploded view, respectively. The assembly shown in FIGS. 1A and 1B includes a base plate 10, tissue 20 (e.g., skin), mold plate 30 (e.g., TEFLON mold plate), cover plate 40, and fasteners 50.

The containers defined by the holes 90, 100 and either the base plate 10 or tissue 20 function as molds, containing the hydrogel precursor solution and defining the shape and dimensions of the formed hydrogel sample upon polymerization or curing. The shape and size of the containers may be selected to obtain a hydrogel sample of any desired size and shape. Geometry, size, and materials from which the mold plate 30 and cover plate 40 are made can be readily adapted for use with particular processing conditions and handling devices. For examples, the holes 90, 100 in the mold plate 30 and cover plate 40 may be counter-bored, counter-sunk, stepped, tapered, or more complex-shaped to accommodate the desired shape of the hydrogel sample, once formed. In FIGS. 1A and 1B, they are simply shown as illustrative straight through holes.

Containers for practicing the invention can be comprised of many suitable materials that will not react with the hydrogel precursor solution, that will maintain integrity over the required temperature range, and that will allow the hydrogel to be removed without damaging the hydrogel. Suitable materials include but are not limited to natural and synthetic resins, natural and synthetic polymers (including those based upon polycarbonates, acrylates and methacrylates, and poly(vinyl alcohol)), glass, steel, aluminum, brass, and copper, among other materials. Containers that are compliant and elastic may result in a more complete gelling and better physical properties than containers that are stiff.

Typically, the container is not filled entirely with the hydrogel precursor solution in order to accommodate for changes in volume during formation and/or subsequent property testing. Whatever the purpose to which an embodiment of this invention is put, each container (apart from any containers used as controls, or blanks), will comprise a controlled amount of the hydrogel precursor solution or formed hydrogel and, optionally, one or more additional compounds, such as active ingredients (e.g., bioactive substances). The containers may also contain a stir bar or other device to facilitate stirring, uniform heating, or anything else that is deemed necessary for the particular use to which the invention is being put. All of these materials are optionally added to containers in an automated fashion. For example, hydrogel precursor solutions can be deposited into the containers in a variety of ways, ranging from hand-pipetting to automated liquid and/or solid dispensing. Dispensing of chemicals into the containers is optionally accomplished with an automated reagent dispensing apparatus, such as Cartesian Technologies' PreSys model (available from Cartesian Technologies Inc., 17851 Sky Park Circle, Suite C, Irvine, Calif. 92614, USA), and multiple-channel liquid dispensers, such as those available from Tecan Group Ltd. (Tecan Group Ltd., Seestrasse 103, 8708 Mannedorf, SWITZERLAND). Other models and brands of liquid dispensers can also be used. Solid compounds and compositions can also be dispensed by hand or by automated means known in the art. For example, a solution comprising a compound-of-interest can be dispensed into sample containers, after which the solvent can be removed to provide a controlled amount of the compound-of-interest (e.g., in a milligram or microgram quantity).

Combinatorial Fabrication Method

Another aspect of the invention is a method for fabricating combinatorial hydrogel arrays, comprising: (a) providing hydrogel components (e.g., stock solutions or fluids comprising one or more polymerizable monomers, and/or other useful formulating ingredients, such as solvents (e.g., 1-methyl-2-pyrrolidone (NMP) or water), accelerators, initiators, co-initiators, sensitizers, cross-linking agents, comonomers, active ingredients, excipients, etc.); (b) dispensing the hydrogel components into containers (such as vials, wells, etc.) in order to create varying hydrogel chemistries with or without active ingredients (e.g., a bioactive substance such as an active pharmaceutical ingredient, protein, biologic, etc.); (c) mixing the hydrogel components (optionally, by sonication, addition of mixing rods or balls, or mechanical agitation) to form a hydrogel precursor solution (non-polymerized or uncured, or otherwise polymerizable or curable); (d) optionally, heating the hydrogel precursor solution if necessary, in order to solubilize and further mix hydrogel components together; (e) optionally, providing tissue (such as explanted skin), which may be prepared by stripping, separating, cutting, etc. to the correct geometry and physical state; (f) optionally, affixing the tissue to a planar substrate (e.g., a flat plate), which may be carried out using any means (e.g., tissue adhesive, vacuum grip, mechanical means); (g) providing an array of containers where the hydrogel precursor solutions will be cured, or polymerized, or otherwise formed (optionally, in contact with the tissue affixed in step (f)); (h) transferring hydrogel precursor solutions or sols into the array of containers; (i) polymerizing or curing the hydrogel precursor solutions or sols in the containers (which may be carried out by exposing the hydrogel precursor solutions or sols to radiation (such as ultraviolet (UV), gamma, heat, light, energy, etc.), thereby forming hydrogels (polymerized or cured); and (j) optionally, removing the containers in preparation for further characterization.

Monomers are the individual molecular units that are repeated to form polymers. Multiple monomers covalently attached form the backbone of a polymer. Polymers that are made from at least two different monomer units are referred to as copolymers. Polymerizing or copolymerizing describes the process by which multiple monomers are covalently linked to form polymers or copolymers, respectively. A discussion of polymers and monomers from which they are made may be found in Stevens, Polymer Chemistry: An Introduction, 3^{rd} ed., Oxford University Press, 1999. Monomers useful for fabricating hydrogels in accordance with the present invention include, without limitation, allyl-amine, methylmethacrylate; hydroxyethylmethacrylate; N,N-di-ethylamino ethyl methacrylate; acrylic acid; alkyl methacrylate; alkylacrylates; arylacrylates; acrylamide; methacrylamide; N-methylacrylamide; N-methylmethacrylamide; styrene; para-hydroxy-styrene; para-amino-styrene; vinylpyridine; para-vinyl benzoic acid; 2-vinyl-2-hydroxypyridine; 3-vinyl-2-hydroxypyridine; 4-vinyl-2-hydroxypyridine; 4-vinylbenzamide; N-alkyl-(4-vinylbenzamide); N,N-dialkyl-(4-vinylbenzamide); N,N′-diethyl(4-vinylphenyl)amidine; acrylonitriles; ethacrylamide; alkacrylamides; alkyl substituted alkyl acrylates in general where the alkyl group is an aliphatic or aromatic group; butadiene; caprolactone; ethylene; propylene; divinylbenzene; ethylene glycol; propylene glycol; dimethylsiloxane; lactide; glycolide; ornithine; vinyl acetate; vinyl alcohol; vinyl chloride; vinyl isobutyl ether; vinyl methyl ether; urethane; isocyanates; isothiocyanates; dimethyl aminoethyl acrylate methyl chloride; [2-(methacryloyloxy)ethyl]trimethylammonium chloride; and vinylpyrrolidone. Optionally, the monomers are acrylates or aromatics. For example, the acrylates are selected from the group consisting of methylmethacrylate; hydroxyethylmethacrylate; N,N-di-ethylamino ethyl methacrylate; acrylic acid; and mixtures thereof. For example, aromatics are selected from the group consisting of styrene, para-hydroxy-styrene, para-amino-sytrene, vinylpyridine, para-vinyl benzoic acid, and mixtures thereof. In one embodiment, about 3 to about 9 parts by volume of monomer to cross-linker is utilized. The choice of monomer will depend partially upon the polymerization technique utilized in the polymerizing step. Optionally, the monomers are polymerized using addition polymerization. However, other methods of polymerization, such as condensation polymerization, may be utilized.

Co-monomers can also be used to formulate hydrogels in accordance with the present invention. Co-monomers are especially useful when the monomer is a macromolecule, in which case, any of the smaller acrylate, vinyl or allyl compounds are useful. Co-monomers can also act as accelerators of the reaction, by their greater mobility, or by stabilizing radicals. Of particular interest are N-vinyl compounds, including N-vinyl pyrrolidone, N-vinyl acetamide, N-vinyl imidazole, N-vinyl caprolactam, and N-vinyl formamide.

Cross-linking agents (also referred to herein as “cross-linkers”) useful for formulating hydrogels in accordance with the present invention include, without limitation, di-, tri- and tetrafunctional acrylates or methacrylates, divinyl benzene, alkylene glycol, polyalkylene glycol diacrylates, methacrylates, dialkyldiglycol dicarbonate, dialkyl maleate, dialkyl fumurate, dialkyl itaconate, vinyl esters, ethylene glycol dimethacrylate, ethylene glycol diacrylate, di-ethylene glycol diacrylate, tri-ethylene glycol diacrylate, tetra-ethylene glycol diacrylate, vinyl acrylates, vinyl methacrylates, alkyl acrylates, vinyl methacrylates, divinylbenzene, diallyldiglycol dicarbonate, diallyl maleate, diallyl fumarate, diallyl itaconate, vinyl esters such as divinyl oxalate, divinyl malonate, diallyl succinate, triallyl isocyanurate, the dimethacrylates or diacrylates of bis-phenol A or ethoxylated bis-phenol A, methylene or polymethylene bisacrylamide or bismethacrylamide, including hexamethylene bisacrylamide or hexamethylene bismethacrylamide, di(alkene) tertiary amines, trimethylol propane triacrylate, pentaerythritol tetraacrylate, divinyl ether, divinyl sulfone, diallyl phthalate, triallyl melamine, 2-isocyanatoethyl methacrylate, 2-isocyanatoethylacrylate, 3-isocyanatopropylacrylate, 1-methyl-2-isocyanatoethyl methacrylate, 1,1-dimethyl-2-isocyanaotoethyl acrylate, tetraethylene glycol diacrylate, tetraethylene glycol dimethacrylate, triethylene glycol dimethacrylate, hexanediol dimethacrylate, and hexanediol diacrylate. Optionally, the cross-linker utilized in the methods of the present invention is di-ethylene glycol diacrylate.

Polymerization can be initiated by any known applicable mechanism, including photochemical (e.g., using a UV lamp), thermal (e.g., using ammonium persulfate (APS)) and oxidation-reduction reactions (e.g., using APS/sodium metabisulfite (SMBS) or APS/tetramethylethylene diamine (TMEDA). Photopolymerization is one method that may be used to cross-link a liquid, macromer solution to form a hydrogel with significant temporal and spatial control (Sawhney A. S. et al., Biomaterials, 1993, 14(13):1008-1016; Elisseef J. et al., Proc. Natl. Acad. Sci. USA, 1999, 96(6):3104-3107; Mann B. K. et al., Biomaterials, 2001, 22(22):3045-3051; Schmedlen R. H. et al., Biomaterials, 2002, 23(22):4325-4332; Masters K. S. et al., Wound Repair Regen., 2002, 10(5):286-294). The polymerizing step can be initiated using polymerization initiators such as those known to those skilled in the art including, without limitation, ultraviolet or thermal free radical initiators such as peroxides, azo compounds (e.g., azo-bis-isobutyronitrile), or redox based compounds. For example, the initiator may be selected from the group consisting of benzol peroxide, acetyl peroxide, lauryl peroxide, azobisisobutyronitrile, 2,2′-Azobis(2-methylpropionamidine)dihydrochloride, t-butyl peracetate, cumyl peroxide, t-butyl peroxide, t-butyl hydroperoxide, bis(isopropyl)peroxy-dicarbonate, benzoin methyl ether, 2,2′-azobis(2,4-dimethylvaleronitrile), tert-butyl peroctoate, phtalic peroxide, diethoxyacetophenon, tert-butyl peroxyypivalate, diethoxyacetophenone, 1-hydroxycyclohexyl phenyl ketone, 2,2-dimethoxy-2-phenyl-acetophenone, phenothiazine, azo bis(2-methyl proplon amidine) di-hydrochloride, TEMED (N,N,N′,N′-tetramethylethylenediamine), APS (ammonium persulfate), and diisopropylxanthogen disulfide.

Thus, the term “initiator” is used herein in a broad sense, in that it is a substance which under appropriate conditions will result in the polymerization of a monomer. Materials for initiation may be photoinitiators, chemical initiators, thermal initiators, photosensitizers, co-catalysts, chain transfer agents, and radical transfer agents. The initiator should be non-toxic when used in vivo, at least in the amounts applied. In a specific embodiment, the initiator is a photoinitiator. In discussing photoinitiators, a distinction may be drawn between photosensitizers and photoinitiators—the former absorb radiation efficiently, but do not initiate polymerization well unless the excitation is transferred to an effective initiator or carrier. Photoinitiators as referred to herein include both photosensitizers and photoinitiators, unless otherwise noted.

Photoinitiators provide important curing mechanisms for addition polymerization, and especially for curing of ethylenically-unsaturated compounds, such as vinylic and acrylic-based monomers. Any of the photoinitiators found in the art may be suitable. Examples of photo-oxidizable and photo-reducible dyes that may be used to initiate polymerization include acridine dyes, for example, acriblarine; thiazine dyes, for example, thionine; xanthine dyes, for example, rose Bengal; and phenazine dyes, for example, methylene blue. Other initiators include camphorquinones and acetophenone derivatives. Photoinitiation is one specific method of polymerizing the hydrogel precursor solution.

The choice of the photoinitiator is largely dependent on the photopolymerizable regions. For example, when the macromer includes at least one carbon-carbon double bond, light absorption by the dye causes the dye to assume a triplet state, the triplet state subsequently reacting with the amine to form a free radical which initiates polymerization. In an alternative mechanism, the initiator splits into radical-bearing fragments which initiate the reaction. For example, dyes for use with these materials include eosin dye and initiators such as 2,2-dimethyl-2-phenylacetophenone, 2 methoxy-2-phenylacetophenone, DAROCUR 2959, IRGACURE 651, and camphorquinone. Using such initiators, copolymers may be polymerized by long wavelength ultraviolet light or by light of about 514 nm, for example. In one embodiment, a photoinitiator for biological use is Eosin Y, which absorbs strongly to most tissue and is an efficient photoinitiator. It is known in the art of photopolymerization to use a wavelength of light which is appropriate for the activation of a particular initiator. Light sources of particular wavelengths or bands are well-known.

Thermal polymerization initiator systems may also be used. Systems that are unstable at 37° C. and initiate free radical polymerization at physiological temperatures include, for example, potassium persulfate, with or without tetramethyl ethylenediamine; benzoyl peroxide, with or without triethanolamine; and ammonium persulfate with sodium bisulfite. Other peroxygen compounds include t-butyl peroxide, hydrogen peroxide, and cumene peroxide. As described below, it is possible to markedly accelerate the rate of a redox polymerization by including metal ions in the solution, especially transition metal ions such as the ferrous ion. It is further shown below, that a catalysed redox reaction can be prepared so that the redox-catalysed polymerization is very slow, but can be sped up dramatically by stimulation of a photoinitiator present in the solution.

A further class of initiators is provided by compounds sensitive to water, which form radicals in its presence. An example of such a material is tri-n-butyl borane, the use of which is described below.

Metal ions can be either an oxidizer or a reductant in systems including redox initiators. For example, ferrous ion can be used in combination with a peroxide to initiate polymerization, or as parts of a polymerization system. In this case the ferrous ion is serving as reductant. Other systems are known in which a metal ion acts as oxidant. For example, the ceric ion (4+valence state of cerium) can interact with various organic groups, including carboxylic acids and urethanes, to remove an electron to the metal ion, and leaving an initiating radical behind on the organic group. In this case, the metal ion acts as an oxidizer. Potentially suitable metal ions for either role are any of the transition metal ions, lanthanides and actinides, which have at least two readily accessible oxidation states. Several metal ions have at least two states separated by only one difference in charge. Of these, the most commonly used are ferric/ferrous; cupric/cuprous; ceric/cerous; cobaltic/cobaltous; vanadate V vs. IV; permanganate; and manganic/manganous.

Any of the compounds typically used in the art as radical generators or co-initiators in photoinitiation may be used. These include co-catalysts or co-initiators such as amines, for example, triethanolamine, as well as other trialkyl amines and trialkylol amines; sulfur compounds; heterocycles, for example, imidazole; enolates; organometallics; and other compounds, such as N-phenyl glycine.

Other compounds can be added to the hydrogel precursor solutions prior to polymerization or curing. Surfactants may be included to stabilize any of the materials, either during storage or in a form reconstituted for application. Similarly, stabilizers which prevent premature polymerization may be included; typically, these are quinones, hydroquinones, or hindered phenols. Plasticizers may be included to control the mechanical properties of the final hydrogels. These are also well-known in the art, and include small molecules such as glycols and glycerol, and macromolecules such as polyethylene glycol.

Optionally, particles of a disintegrant, which have been found to be effective in increasing the swelling rate and capacity of hydrogels, can also be included in the hydrogel precursor solutions. Examples of such disintegrants and their use can be found in U.S. Pat. No. 6,271,278, the disclosure of which is incorporated herein by reference in its entirety. Whenever such disintegrant particles are employed it is preferred that they are selected from crosslinked natural and synthetic polymers, such as crosslinked derivatives of sodium carboxymethylcellulose, sodium starch glycolate, sodium carboxymethyl starch, dextran, dextran sulfate, chitosan, xanthan, gellan, hyaluronic acid, sodium alginate, pectinic acid, deoxyribonucleic acids, ribonucleic acid, gelatin, albumin, polyacrolein potassium, sodium glycine carbonate, poly(acrylic acid) and its salts, polyacrylamide, poly(styrene sulfonate), poly(aspartic acid) and polylysine. Further examples include cross-linked neutral, hydrophilic polymers, such as those of polyvinylpyrrolidone, ultramylopectin, poly(ethylene glycol), neutral cellulose derivatives, microcrystalline cellulose, powdered cellulose, cellulose fibers and starch. Non-crosslinked forms of the above-mentioned polymers having a particulate shape as well as porous inorganic materials that provide wicking by capillary forces can also be used.

The hydrogel precursor solution also may include a responsive substance to contribute a desired responsiveness of the polymerized hydrogel to the physical, chemical, or biological parameter in the medium in which the hydrogel is to ultimately be placed. The responsive substance may or may not be cross-linked to the hydrogel after polymerization. For example, 3-methylacrylamidophenylboronic acid and Concavalin A can render a hydrogel glucose-sensitive.

The hydrogel precursor solution can include optional additives, such as dyes (see, for example, U.S. Pat. No. 5,534,038), surface active agents, viscosity modifiers, thixotropic agents, pigments, flow agents, thickeners, plasticizers, and other additives to modify a physical property of the polymerizable solution or the hydrogel. As one of skill in the art will recognize, the amount of additive required will vary with the intended purpose and the hydrogel composition.

If the hydrogel is to be used in vivo (e.g., as a component of an implantable medical device, or as a drug delivery vehicle, or as a surgical adhesive), the hydrogel is optionally biocompatible in order to minimize any inflammatory or toxic responses. Alternatively, the hydrogel may be isolated from direct contact with the blood, plasma, interstitial fluids, or tissue of the patient through the use of molecular weight cut-off membranes, films, and the like. Such a system would prevent patient-exposure to any toxic hydrogel-derived compounds, but ensure adequate exposure of the hydrogel component to the medium.

Buffers for use in the method of the present invention should be un-reactive to the polymerization step, and if the hydrogel is to be used in vivo, should be biocompatible (unless the hydrogel is to be isolated from direct contact with the patient or the patient's body fluids). Any number of known buffers may be used, including, without limitation, phosphate buffered saline, phosphate, HEPES, and TRIS buffers. Any solvents should also not be reactive to polymerization, should be biocompatible if necessary, and can optionally have a low molecular weight and boiling point. Solvents contemplated for use in the present invention include ethanol, methanol, ethers, ketones (e.g., acetone), dioxane, DMSO, water, and aliphatic and aromatic hydrocarbons.

Hydrogels fabricated using the fabrication method of the invention may be utilized as hydrogel samples in other methods of the invention designed to characterize the properties possessed by the hydrogels.

Methods and Systems for Characterizing Arrayed Hydrogels

In another aspect, the invention includes a method for testing properties of arrayed hydrogel samples, comprising providing an array of hydrogel samples, each of which is held in a container; exposing the hydrogel samples to a condition, such as heat, cold, mechanical perturbation, contact with a receptor solution, etc.; collecting and analyzing data obtained from one or more of the samples; and optionally, separating hydrogel samples of interest from other hydrogel samples for further testing and analysis.

In one embodiment, the invention encompasses a method for testing the bulk and interfacial mechanical properties of arrayed hydrogel samples, comprising: (a) contacting a hydrogel sample with a test probe attached to a mechanical tester with a force transducer and load cell, such as an Instron machine or texture analyzer; (b) optionally, bonding or mechanically attaching the test probe to the hydrogel sample (such as by gripping the hydrogel sample, gluing to the hydrogel sample, vacuuming, or other means of attachment); (c) perturbing the hydrogel sample in tension, compression, and shear mode; and (d) measuring the resultant force and deflections over time, in order to characterize the bulk and adhesive properties of the hydrogel sample and, optionally, the hydrogel-tissue interfacial bond.

In another embodiment, the invention encompasses a method for assessing the release characteristics (e.g., drug elution) of arrayed hydrogels, comprising: (a) providing an array of hydrogel samples containing active ingredients (e.g., a bioactive substance such as a drug, protein, biologic, etc.); (b) forming an array of receptor wells onto the exposed surface of the hydrogel samples; (c) dispensing an appropriate receptor solution (such as buffers, simulated body fluids, etc.) into the receptor wells (the dispensed receptor solution may be circulating or static, for example); (d) obtaining samples of the receptor solution in the receptor wells over time; (e) optionally, replacing the receptor well solution; and (f) analyzing the receptor solution samples to determine the concentration of the active ingredient (e.g., bioactive substance) released from the hydrogel over time.

Optionally, prior to forming the array of receptor wells, the hydrogel samples are prepared by providing an array of hydrogel precursor solutions and polymerizing the hydrogel precursor solutions, as carried out in the fabrication method of the invention.

In other aspects of the invention, the aforementioned method for assessing the release characteristics of hydrogels is modified for the purpose of assessing other product characteristics that are important for biomedical applications, such as partitioning into explanted tissue samples, permeation through explanted tissue samples, hemostasis and blood compatibility, stability of a bioactive substance (e.g., drug stability) over time, hydrogel degradation rate, and cell-based characteristics, such as cytotoxicity, inflammation, etc.

The present invention also includes systems for fabricating arrays of hydrogels, such as those fabricated on tissue in situ or processed in the absence of tissue (e.g., in a plate or mold assembly), and to test the properties of fabricated hydrogels.

In another aspect, the invention includes a system for fabricating hydrogels, comprising a means for dispensing chemicals such as balances, pipetters, etc. to prepare stock solutions and fluids of hydrogel components (e.g., one or more polymerizable monomers, and/or other useful formulating ingredients, such as accelerators, initiators, co-initiators, sensitizers, cross-linking agents, comonomers, active ingredients, excipients, etc.); combinatorial dispensers to create combinations of chemicals that will form the varying hydrogel chemistries; means for mixing, heating, and/or maintaining samples at their processing temperature (e.g., mixers, heaters, oven); optionally, tissue preparation tools and fixtures; optionally, fixtures to affix tissue (e.g., a planar substrate to which tissue is bonded or mechanically affixed), and create an array of wells or molds where the samples will be formed (such as a mold with multiple cavities, composed of TEFLON or other material); liquid handling equipment (such as single- or multi-channel pipettors) to transfer the hydrogel solutions into the wells; and an energy source (such as a UV lamp or e-beam source, etc.) to polymerize or cure the hydrogels.

In a specific embodiment, the aforementioned system for fabricating hydrogels comprises manual chemical dispensing tools, scales; stirrers, heated mixers, and a solvent oven; skin tissue heat-separation tools; a variety of metal substrates in standard SBS microplate format to affix the skin tissue to a rigid flat surface, create multiple wells or mold for casting the hydrogels, clamp the various layers together, and obtain a liquid-tight seal among them; single-channel, manually operated pipetters for dispensing the hydrogels into the molds; and a UV lamp.

In another aspect, the invention includes a system for testing the mechanical bulk and interfacial properties of arrayed hydrogels, comprising a mechanical testing instrument that can perturb arrayed hydrogel samples in a controlled fashion and measure the resulting forces and deflections over time (such as an INSTRON or TEXTURE ANALYZER instrument); a test probe that couples the load cell of the testing instrument to the hydrogel sample (this may be a reusable or a disposable probe, for example); an adhesive dispenser to apply an adhesive to bond the probe to the hydrogel samples, or a fixture to grip the hydrogel sample (such as a vacuum chuck or mechanical grippers) or to grip a part that has been bonded to the hydrogel sample; a recording instrument (such as a personal computer (PC) and accompanying software) to gather the results and control the sequence of each test; optionally, an automated stage to index the plurality of samples into the test position(s); and an environmental-control chamber that allows for temperature and/or humidity control while the samples are tested.

In a specific embodiment, the aforementioned system for testing the mechanical bulk and interfacial properties of arrayed hydrogels comprises a TEXTURE ANALYZER TA-TX2plus testing instrument; a PC, with custom software; disposable probes, threaded to the load cell of the testing instrument and bonded with cyanoacrylate glue (e.g., LOCTITE) to the hydrogel samples; automated indexing stage and fixturing to hold the sample arrays; and a humidity and temperature-controlled chamber.

In other aspects of the invention, the aforementioned system for testing the mechanical bulk and interfacial properties of arrayed hydrogels is modified to be used as a tool for the purpose of testing elution, degradation rates, water content, and related methods. These modifications may include one or more of the following: additional fixturing to create receptor wells on the exposed surfaces of the samples; liquid handling equipment to dispense or continuously flow fluids over the samples, as well as to sample the fluids, which contain the analyte of interest; surface-measurement instruments or sensors may be required to detect changes in the topology of samples (water absorption/loss, change in volume, etc); optical tools (e.g., imaging devices and image-analysis equipment) to detect changes in geometry as well as optical properties of the samples; spectroscopy and other analytical devices to determine changes in the chemical composition of the samples (Raman, IR, XRD, HPLC, etc.)

The hydrogels that are fabricated, formulated, and characterized using the methods and apparatuses of the invention are potentially useful as surgical biomaterials, transdermal materials, coatings, and other classes of materials. For example, the hydrogels can be used in product classes such as bioadhesives (e.g., mucoadhesives), sealants, wound dressings, tissue securement devices and materials, device coatings (such as stent coatings), hemostatic materials/devices (homeostatic), drug delivery matrices, and combination devices (such as drug eluting bioadhesives). Such materials are useful for products in the surgical biomaterials arena, as well as in transdermal drug delivery, opthalmics, mucosal delivery, nasal delivery, vaginal delivery, stent-based delivery, implant depot delivery, etc.

The methods and apparatuses of the invention can be used for synthesizing hydrogel polymers of several types, using combinatorial addition of various functional monomers. The hydrogels that are synthesized can be made to be lubricious and non-sticky, such as in the case for anti-adhesion films and other products. The hydrogels may be formulated to contain active ingredients such as pharmaceuticals (e.g., drugs) for application in drug-eluting coatings. To this end, hydrogel samples can be screened to test for elution and/or permeability over time using plate-based dissolution methods.

The polymerization energy and energy sources used in the methods, systems, and apparatuses of the invention need not be confined to UV light and UV light sources. For example, gamma rays, light, Ebeam, heat, or other means of energy can be used to polymerize the monomers or macromers together or to form crosslinks.

The mechanical analysis can include probes or other fixtures that measure peel strength and other mechanical modes such as testing in shear. Or, samples can be brought into contact with tissue for the first time and then de-bonded to measure tack for samples such as muco-adhesives, which become tacky to hydrophilic and wet surfaces and tissues or anti-adhesion products where any adhesion to tissue would be unwanted.

Other important product characteristics may also be measured using an arrayed sample format (e.g., rows, columns etc.) of hydrogels and varied by manipulating the composition and processing conditions using combinatorial techniques and plate-based processing. These aspects include, but are not limited to, protein adsorption; cell viability inside the hydrogel; cell proliferation, migration, and growth in the hydrogels; drug binding to the hydrogel; drug elution from the hydrogel; drug partitioning from the hydrogel into tissue; lubricity; muco-adhesiveness; buffering capacity of the hydrogel; ionic strength of the hydrogel; thrombogenetic potential of the hydrogel (hemostasis assays on hydrogels); and degradation rate of the hydrogels in various media.

The present invention further relates to methods and apparatus to prepare a large number of hydrogel precursor solutions, at varying concentrations and identities, at the same time, and methods to test tissue barrier transfer of components within the hydrogel solutions in each combination. The methods of the present invention allow determination of the effects of additional or inactive components, such as excipients, carriers, enhancers, adhesives, and additives, on transfer of active components, such as pharmaceuticals, across tissue, such as skin or stratum corneum, lung tissue, tracheal tissue, nasal tissue, bladder tissue, placenta, vaginal tissue, rectal tissue, stomach tissue, gastrointestinal tissue, nail (finger or toe nail), eye or corneal tissue, and plant tissue (leaf, stem or root). The invention thus encompasses the testing of hydrogel solutions in order to determine the overall optimal composition or formulation for improved tissue transport, including without limitation, transdermal transport.

The tensile properties of the hydrogels fabricated using the methods and apparatuses of the present invention may be characterized by their deformation behavior. Rubbery polymers tend to exhibit a lower modulus, or stiffness, and extensibilities which are high. Glassy and semi-crystalline polymers have higher moduli and lower extensibilities.

Definitions

As used herein, the term “array” means a plurality of samples, for example, at least 2 samples, each sample comprising a hydrogel precursor solution (i.e., an unpolymerized or uncured hydrogel; a polymerizable or curable hydrogel) or a hydrogel (polymerized or cured). Optionally, the hydrogel precursor solution or hydrogel includes one or more active ingredients representing a compound-of-interest.

As used herein, the term “biocompatibility,” in the context of biologically-related uses, refers to the absence of stimulation of a severe, long-lived or escalating biological response to a hydrogel or hydrogel precursor solution, and is distinguished from a mild, transient inflammation which typically accompanies surgery or implantation of foreign objects into a living organism.

As used herein, the term “biodegradability” refers to the disintegration, which is frequently predictable, of a hydrogel or hydrogel precursor solution into small entities which will be metabolized or excreted, under the conditions normally present in a living tissue.

The term “compound-of-interest” means the common active ingredient present in an array of samples where the array is designed to study its physical, mechanical and/or chemical properties. The compound-of-interest may also be a particular compound for which it is desired to find conditions or compositions that inhibit, prevent, or promote its release or elution from the hydrogel. Optionally, the compound-of-interest is present in every sample of the array, with the exception of negative controls. For example, the compound-of-interest may be present in every sample of the array in varying concentrations. However, different compounds-of-interest may be present in various portions of the array, for example. Examples of compounds-of-interest include, but are not limited to, bioactive substances such as pharmaceuticals, dietary supplements, alternative medicines, nutraceuticals, sensory compounds, agrochemicals, the active component of a consumer formulation, and the active component of an industrial formulation. Optionally, the compound-of-interest is a pharmaceutical. The compound-of-interest can be a known or novel compound. For example, the compound-of-interest can be a known compound in commercial use.

As used herein, the term “pharmaceutical” means any bioactive substance that has a therapeutic, disease preventive, diagnostic, or prophylactic effect when administered to an animal or a human. The term pharmaceutical includes prescription pharmaceuticals and over the counter pharmaceuticals. Pharmaceuticals suitable for use in the invention include all those known or to be developed. A pharmaceutical can be a large molecule (i.e., molecules having a molecular weight of greater than about 1000 g/mol), such as oligonucleotides, polynucleotides, oligonucleotide conjugates, polynucleotide conjugates, proteins, peptides, peptidomimetics, or polysaccharides or small molecules (i.e., molecules having a molecular weight of less than about 1000 g/mol), such as hormones, steroids, nucleotides, nucleosides, or amino acids. Examples of suitable small molecule pharmaceuticals include, but are not limited to, cardiovascular pharmaceuticals, such as amlodipine, losartan, irbesartan, diltiazem, clopidogrel, digoxin, abciximab, furosemide, amiodarone, beraprost, tocopheryl; anti-infective components, such as amoxicillin, clavulanate, azithromycin, itraconazole, acyclovir, fluconazole, terbinafine, erythromycin, and acetyl sulfisoxazole; psychotherapeutic components, such as sertaline, vanlafaxine, bupropion, olanzapine, buspirone, alprazolam, methylphenidate, fluvoxamine, and ergoloid; gastrointestinal products, such as lansoprazole, ranitidine, famotidine, ondansetron, granisetron, sulfasalazine, and infliximab; respiratory therapies, such as loratadine, fexofenadine, cetirizine, fluticasone, salmeterol, and budesonide; cholesterol reducers, such as atorvastatin calcium, lovastatin, bezafibrate, ciprofibrate, and gemfibrozil; cancer and cancer-related therapies, such as paclitaxel, carboplatin, tamoxifen, docetaxel, epirubicin, leuprolide, bicalutamide, goserelin implant, irinotecan, gemcitabine, and sargramostim; blood modifiers, such as epoetin alfa, enoxaparin sodium, and antihemophilic factor; antiarthritic components, such as celecoxib, nabumetone, misoprostol, and rofecoxib; AIDS and AIDS-related pharmaceuticals, such as lamivudine, indinavir, stavudine, and lamivudine; diabetes and diabetes-related therapies, such as metformin, troglitazone, and acarbose; biologicals, such as hepatitis B vaccine, and hepatitis A vaccine; hormones, such as estradiol, mycophenolate mofetil, and methylprednisolone; analgesics, such as tramadol hydrochloride, fentanyl, metamizole, ketoprofen, morphine, lysine acetylsalicylate, ketoralac tromethamine, loxoprofen, and ibuprofen; dermatological products, such as isotretinoin and clindamycin; anesthetics, such as propofol, midazolam, and lidocaine hydrochloride; migraine therapies, such as sumatriptan, zolmitriptan, and rizatriptan; sedatives and hypnotics, such as zolpidem, zolpidem, triazolam, and hycosine butylbromide; imaging components, such as iohexol, technetium, TC99M, sestamibi, iomeprol, gadodiamide, ioversol, and iopromide; and diagnostic and contrast components, such as alsactide, americium, betazole, histamine, mannitol, metyrapone, petagastrin, phentolamine, radioactive B₁₂, gadodiamide, gadopentetic acid, gadoteridol, and perflubron. Other pharmaceuticals for use in the invention include those listed in Table 1 below, which suffer from problems that could be mitigated by developing new administration formulations according to the arrays and methods of the invention.

TABLE 1
Exemplary Pharmaceuticals

| Brand Name | Chemical | Properties |
|---|---|---|
| SANDIMMUNE | cyclosporin | Poor absorption in part due |
| | | to its low water solubility. |
| TAXOL | paclitaxel | Poor absorption due to its |
| | | low water solubility. |
| VIAGRA | sildenafil | Poor absorption due to its |
| | | low water citrate solubility. |
| NORVIR | ritonavir | Can undergo a polymorphic |
| | | shift during shipping and |
| | | storage. |
| FULVICIN | griseofulvin | Poor absorption due to its |
| | | low water solubility. |
| FORTOVASE | saquinavir | Poor absorption due to its |
| | | low water solubility. |

Still other examples of suitable pharmaceuticals are listed in 2000 Med Ad News 19:56-60 and The Physicians Desk Reference, 53rd edition, 792-796, Medical Economics Company (1999), both of which are incorporated herein by reference in their entirety.

Examples of suitable veterinary pharmaceuticals include, but are not limited to, vaccines, antibiotics, growth enhancing components, and dewormers. Other examples of suitable veterinary pharmaceuticals are listed in The Merck Veterinary Manual, 8th ed., Merck and Co., Inc., Rahway, N.J., 1998; (1997) The Encyclopedia of Chemical Technology, 24 Kirk-Othomer (4^{th} ed. at 826); and Veterinary Drugs in ECT2nd ed., Vol 21, by A. L. Shore and R. J. Magee, American Cyanamid Co.

As used herein, the term “dietary supplement” means a non-caloric or insignificant-caloric bioactive substance administered to an animal or a human to provide a nutritional benefit or a non-caloric or insignificant-caloric substance administered in a food to impart the food with an aesthetic, textural, stabilizing, or nutritional benefit. Dietary supplements include, but are not limited to, fat binders, such as caducean; fish oils; plant extracts, such as garlic and pepper extracts; vitamins and minerals; food additives, such as preservatives, acidulents, anticaking components, antifoaming components, antioxidants, bulking components, coloring components, curing components, dietary fibers, emulsifiers, enzymes, firming components, humectants, leavening components, lubricants, non-nutritive sweeteners, food-grade solvents, thickeners; fat substitutes, and flavor enhancers; and dietary aids, such as appetite suppressants. Examples of suitable dietary supplements are listed in (1994) The Encyclopedia of Chemical Technology, 11 Kirk-Othomer (4^{th} ed. at 805-833). Examples of suitable vitamins are listed in (1998) The Encyclopedia of Chemical Technology, 25 Kirk-Othomer (4^{th} ed. at 1) and Goodman & Gilman's: The Pharmacological Basis of Therapeutics, 9th Edition, eds. Joel G. Harman and Lee E. Limbird, McGraw-Hill, 1996 p. 1547, both of which are incorporated by reference herein. Examples of suitable minerals are listed in The Encyclopedia of Chemical Technology, 16 Kirk-Othomer (4^{th} ed. at 746) and “Mineral Nutrients” in ECT 3^{rd} ed., Vol 15, pp. 570-603, by C. L. Rollinson and M. G. Enig, University of Maryland, both of which are incorporated herein by reference in their entirety.

As used herein, the term “alternative medicine” means a bioactive substance, for example a natural substance, such as an herb or an herb extract or concentrate, administered to a subject or a patient for the treatment of disease or for general health or well being, wherein the substance does not require approval by the FDA. Examples of suitable alternative medicines include, but are not limited to, ginkgo biloba, ginseng root, valerian root, oak bark, kava kava, echinacea, harpagophyti radix, others are listed in The Complete German Commission E Monographs: Therapeutic Guide to Herbal Medicine, Mark Blumenthal et al. eds., Integrative Medicine Communications 1998, which is incorporated by reference herein in its entirety.

As used herein the term “nutraceutical” means a food or food product having both caloric value and pharmaceutical or therapeutic properties. Example of nutraceuticals include garlic, pepper, brans and fibers, and health drinks. Examples of suitable Nutraceuticals are listed in M. C. Linder, ed. Nutritional Biochemistry and Metabolism with Clinical Applications, Elsevier, N.Y., 1985; Pszczola et al., 1998 Food technology 52:30-37 and Shukla et al., 1992 Cereal Foods World 37:665-666.

As used herein, the term “sensory-material” means any chemical or substance, known or to be developed, that is used to provide an olfactory or taste effect in a human or an animal, for example, a fragrance material, a flavor material, or a spice. A sensory-material also includes any chemical or substance used to mask an odor or taste. Examples of suitable fragrances materials include, but are not limited to, musk materials, such as civetone, ambrettolide, ethylene brassylate, musk xylene, TONALIDE, and GLAXOLIDE; amber materials, such as ambrox, ambreinolide, and ambrinol; sandalwood materials, such as alpha-santalol, beta-santalol, SANDALORE, and BACDANOL; patchouli and woody materials, such as patchouli oil, patchouli alcohol, TIMBEROL and POLYWOOD; materials with floral odors, such as GIVESCONE, damascone, irones, linalool, LILIAL, LILESTRALIS, and dihydrojasmonate. Other examples of suitable fragrance materials for use in the invention are listed in Perfumes: Art, Science, Technology, P. M. Muller ed. Elsevier, N.Y., 1991, which is incorporated herein by reference in its entirety. Examples of suitable flavor materials include, but are not limited to, benzaldehyde, anethole, dimethyl sulfide, vanillin, methyl anthranilate, nootkatone, and cinnamyl acetate. Examples of suitable spices include but are not limited to allspice, tarrogon, clove, pepper, sage, thyme, and coriander. Other examples of suitable flavor materials and spices are listed in Flavor and Fragrance Materials-1989, Allured Publishing Corp. Wheaton, Ill., 1989; Bauer and Garbe Common Flavor and Fragrance Materials, VCH Verlagsgesellschaft, Weinheim, 1985; and (1994) The Encyclopedia of Chemical Technology, 11 Kirk-Othomer (4^{th} ed. at 1-61), all of which are incorporated by reference herein in their-entirety.

As used herein, the term “agrochemical” means any substance known or to be developed that is used on the farm, yard, or in the house or living area to benefit gardens, crops, ornamental plants, shrubs, or vegetables or kill insects, plants, or fungi. Examples of suitable agrochemicals for use in the invention include pesticides, herbicides, fungicides, insect repellants, fertilizers, and growth enhancers. For a discussion of agrochemicals, see The Agrochemicals Handbook (1987) 2nd Edition, Hartley and Kidd, editors: The Royal Society of Chemistry, Nottingham, England.

Pesticides include chemicals, compounds, and substances administered to kill vermin or pests such as bugs, mice, and rats and to repel garden pests such as deer and woodchucks. Examples of suitable pesticides that can be used according to the invention include, but are not limited to, abamectin (acaricide), bifenthrin (acaricide), cyphenothrin (insecticide), imidacloprid (insecticide), and prallethrin (insecticide). Other examples of suitable pesticides for use in the invention are listed in Crop Protection Chemicals Reference, 6th ed., Chemical and Pharmaceutical Press, John Wiley & Sons Inc., New York, 1990; (1996) The Encyclopedia of Chemical Technology, 18 Kirk-Othomer (4^{th} ed. at 311-341); and Hayes et al., Handbook of Pesticide Toxicology, Academic Press, Inc., San Diego, Calif., 1990, all of which are incorporated by reference herein in their entirety.

Herbicides include selective and non-selective chemicals, compounds, and substances administered to kill plants or inhibit plant growth. Examples of suitable herbicides include, but are not limited to, photosystem I inhibitors, such as actifluorfen; photosystem II inhibitors, such as atrazine; bleaching herbicides, such as fluridone and difunon; chlorophyll biosynthesis inhibitors, such as DTP, clethodim, sethoxydim, methyl haloxyfop, tralkoxydim, and alacholor; inducers of damage to antioxidative system, such as paraquat; amino-acid and nucleotide biosynthesis inhibitors, such as phaseolotoxin and imazapyr; cell division inhibitors, such as pronamide; and plant growth regulator synthesis and function inhibitors, such as dicamba, chloramben, dichlofop, and ancymidol. Other examples of suitable herbicides are listed in Herbicide Handbook, 6th ed., Weed Science Society of America, Champaign, Ill. 1989; (1995) The Encyclopedia of Chemical Technology, 13 Kirk-Othomer (4^{th} ed. at 73-136); and Duke, Handbook of Biologically Active Phytochemicals and Their Activities, CRC Press, Boca Raton, Fla., 1992, all of which are incorporated herein by reference in their entirety.

Fungicides include chemicals, compounds, and substances administered to plants and crops that selectively or non-selectively kill fungi. For use in the invention, a fungicide can be systemic or non-systemic. Examples of suitable non-systemic fungicides include, but are not limited to, thiocarbamate and thiurame derivatives, such as ferbam, ziram, thiram, and nabam; imides, such as captan, folpet, captafol, and dichlofluanid; aromatic hydrocarbons, such as quintozene, dinocap, and chloroneb; dicarboximides, such as vinclozolin, chlozolinate, and iprodione. Examples of systemic fungicides include, but are not limited to, mitochondiral respiration inhibitors, such as carboxin, oxycarboxin, flutolanil, fenfuram, mepronil, and methfuroxam; microtubulin polymerization inhibitors, such as thiabendazole, fuberidazole, carbendazim, and benomyl; inhibitors of sterol biosynthesis, such as triforine, fenarimol, nuarimol, imazalil, triadimefon, propiconazole, flusilazole, dodemorph, tridemorph, and fenpropidin; and RNA biosynthesis inhibitors, such as ethirimol and dimethirimol; phopholipic biosynthesis inhibitors, such as ediphenphos and iprobenphos. Other examples of suitable fungicides are listed in Torgeson, ed., Fungicides: An Advanced Treatise, Vols. 1 and 2, Academic Press, Inc., New York, 1967 and (1994) The Encyclopedia of Chemical Technology, 12 Kirk-Othomer (4^{th} ed. at 73-227), all of which are incorporated herein by reference in their entirety.

The arrays, methods, and systems of the invention can be used to identify new hydrogel formulations for consumer and industrial applications (consumer formulations and industrial formulations). As used herein, a “consumer formulation” means a hydrogel formulation for consumer use, not intended to be absorbed or ingested into the body of a human or animal. Consumer formulations include, but are not limited to, cosmetics, such as lotions, facial makeup; antiperspirants and deodorants, shaving products, and nail care products; hair products, such as and shampoos, colorants, conditioners; hand and body soaps; paints; lubricants; adhesives; and detergents and cleaners.

As used herein, an “industrial formulation” means a formulation for industrial use that comprises a hydrogel, and which is not intended to be absorbed or ingested into the body of a human or animal. Industrial formulations include, but are not limited to, polymers; rubbers; plastics; industrial chemicals, such as solvents, bleaching agents, inks, dyes, fire retardants, antifreezes and formulations for deicing roads, cars, trucks, jets, and airplanes; industrial lubricants; industrial adhesives; construction materials, such as cements.

As used herein, the term “excipient” means the substances used to formulate active ingredients into pharmaceutical formulations. Preferably, an excipient does not lower or interfere with the primary therapeutic effect of the active, for example, an excipient is therapeutically inert. The term “excipient” encompasses carriers, solvents, diluents, vehicles, stabilizers, and binders. Excipients can also be those substances present in a pharmaceutical formulation as an indirect result of the manufacturing process. Preferably, excipients are approved for or considered to be safe for human and animal administration, i.e., GRAS substances (generally regarded as safe). GRAS substances are listed by the Food and Drug administration in the Code of Federal Regulations (CFR) at 21 CFR 182 and 21 CFR 184, incorporated herein by reference.

Examples of suitable excipients include, but are not limited to, acidulents, such as lactic acid, hydrochloric acid, and tartaric acid; solubilizing components, such as non-ionic, cationic, and anionic surfactants; absorbents, such as bentonite, cellulose, and kaolin; alkalizing components, such as diethanolamine, potassium citrate, and sodium bicarbonate; anticaking components, such as calcium phosphate tribasic, magnesium trisilicate, and talc; antimicrobial components, such as benzoic acid, sorbic acid, benzyl alcohol, benzethonium chloride, bronopol, alkyl parabens, cetrimide, phenol, phenylmercuric acetate, thimerosol, and phenoxyethanol; antioxidants, such as ascorbic acid, alpha tocopherol, propyl gallate, and sodium metabisulfite; binders, such as acacia, alginic acid, carboxymethyl cellulose, hydroxyethyl cellulose; dextrin, gelatin, guar gum, magnesium aluminum silicate, maltodextrin, povidone, starch, vegetable oil, and zein; buffering components, such as sodium phosphate, malic acid, and potassium citrate; chelating components, such as EDTA, malic acid, and maltol; coating components, such as adjunct sugar, cetyl alcohol, polyvinyl alcohol, carnauba wax, lactose maltitol, titanium dioxide; controlled release vehicles, such as microcrystalline wax, white wax, and yellow wax; desiccants, such as calcium sulfate; detergents, such as sodium lauryl sulfate; diluents, such as calcium phosphate, sorbitol, starch, talc, lactitol, polymethacrylates, sodium chloride, and glyceryl palmitostearate; disintegrants, such as colloidal silicon dioxide, croscarmellose sodium, magnesium aluminum silicate, potassium polacrilin, and sodium starch glycolate; dispersing components, such as poloxamer 386, and polyoxyethylene fatty esters (polysorbates); emollients, such as cetearyl alcohol, lanolin, mineral oil, petrolatum, cholesterol, isopropyl myristate, and lecithin; emulsifying components, such as anionic emulsifying wax, monoethanolamine, and medium chain triglycerides; flavoring components, such as ethyl maltol, ethyl vanillin, fumaric acid, malic acid, maltol, and menthol; humectants, such as glycerin, propylene glycol, sorbitol, and triacetin; lubricants, such as calcium stearate, canola oil, glyceryl palmitosterate, magnesium oxide, poloxymer, sodium benzoate, stearic acid, and zinc stearate; solvents, such as alcohols, benzyl phenylformate, vegetable oils, diethyl phthalate, ethyl oleate, glycerol, glycofurol, for indigo carmine, polyethylene glycol, for sunset yellow, for tartazine, triacetin; stabilizing components, such as cyclodextrins, albumin, xanthan gum; and tonicity components, such as glycerol, dextrose, potassium chloride, and sodium chloride; and mixture thereof. Other examples of suitable excipients, such as binders and fillers are listed in Remington's Pharmaceutical Sciences, 18th Edition, ed. Alfonso Gennaro, Mack Publishing Co. Easton, Pa., 1995 and Handbook of Pharmaceutical Excipients, 3rd Edition, ed. Arthur H. Kibbe, American Pharmaceutical Association, Washington D.C. 2000, both of which are incorporated herein by reference in their entirety.

As used herein, the term “tissue” is intended to include an aggregation of similarly specialized cells united in the performance of one or more specific functions in the body. The tissue can be muscle, nerve, epidermal, or connective tissue, for example. The tissue is optionally a sheet of tissue, such as skin, lung, tracheal, nasal, placental, vaginal, rectal, colon, gut, stomach, bladder, vascular, nail (finger or toe), eye or corneal tissue, or plant tissue (e.g., leaf, stem, or root). For example, the tissue may comprise sectioned arterial vessel or gastrointestinal (GI) tract wall. In another embodiment, tissue is skin tissue or stratum corneum. If human cadaver skin is to be used for tissue, one known method of preparing the tissue specimen entails heat stripping by keeping it in water at 60° C. for two minutes followed by the removal of the epidermis, and storage at 4° C. in a humidified chamber. A piece of epidermis is taken out of the chamber prior to the experiments and placed over the desired substrate. Optionally, the tissue is supported by Nylon mesh (TERKO Inc.) to avoid any damage and to mimic the skin in vivo, which is supported by mechanically strong dermis. The tissue can be that of a vertebrate or invertebrate organism. For example, the tissue can be that of a human or non-human mammal, such as a rodent, bovine, or porcine. The tissue may be a living tissue explant or engineered tissue-equivalent. Examples of a suitable engineered tissue include DERMAGRAFT (Advanced Tissue Sciences, Inc.) and those taught in U.S. Pat. No. 5,266,480, which is incorporated herein by reference in its entirety. Several smaller sizes of tissues can be used, rather than one full plate-size piece.

As used herein, the term “hydrogel” refers to a polymeric material that exhibits the ability to swell in water and to retain a significant portion of water within its structure without dissolving.

The hydrogel formed herein can chemically incorporate an active ingredient, such as a bioactive agent, that reacts with the components of the hydrogel-forming system; this can be accomplished by reacting the active ingredient with the components of the hydrogel-forming system herein. Active ingredients that are not reactive with components of the hydrogel-forming system herein can be physically entrapped within the hydrogel or physically encapsulated within the hydrogel by including them in the reaction mixture subjected to photocrosslinking so that the photocrosslinking causes formation of hydrogel with the active ingredient entrapped therein or encapsulated thereby.

As used herein and unless otherwise indicated, the term “sample” refers to an isolated amount of a hydrogel precursor solution or hydrogel. A typical sample comprises a controlled amount of a hydrogel precursor solution or hydrogel, and may also contain one or more active ingredients, excipients, solvents, additives (e.g., stabilizers and antioxidants), or other compounds or materials. Specific volumes of samples may comprise at least about 5 microliters, 10 microliters, 15 microliters, 20 microliters, 25 microliters, 30 microliters, 40 microliters, 50 microliters, 60 microliters, 70 microliters, 80 microliters, 90 microliters, 100 microliters, 125 microliters, 150 microliters, 175 microliters, 200 microliters, 225 microliters, 250 microliters, 300 microliters, 350 microliters, 400 microliters, 450 microliters, 500 microliters, 600 microliters, 700 microliters, 800 microliters, 900 microliters, 1 milliliter, or more. For example, about 10 microliters, or about 20 microliters, or about 50 microliters, or about 100 microliters are specific volumes of samples.

Some specific non-limiting examples of particular features of the invention are provided below.

### EXAMPLE 1

### Polymerization of Sample Array in the Presence of Epidermal Tissue In-Situ Using Ultraviolet (UV) Light

This example demonstrates that a single hydrogel solution can be formulated, stratum corneum tissue secured onto a flat substrate, and an array of samples polymerized in the presence of the tissue “in-situ” using UV light.

A. Preparation of the Tissue-Containing Plate:

Stratum corneum tissue (the outermost layer of epidermis) was heat-separated, floated onto mesh, and then glued to a flat stainless steel plate such that the hydrophilic side of the tissue faced the plate. To glue the tissue to the plate, a thin layer of cyanoacrylate surgical adhesive (NEXABOND brand) was spread onto the metal plate and the tissue was rolled onto the adhesive from the mesh. Next, a thin composite TEFLON sheet with acrylate adhesive backing was prepared by punching 3 millimeter holes into the sheet, with a regular (uniform) 9 millimeter spacing. The sheet was then applied to the tissue such that the acrylate adhesive adhered to the hydrophobic side of the tissue. The tissue was covered in this way with a thin TEFLON sheet except where the holes exposed the skin. The holes formed “virtual wells” on the tissue.

B. Preparation of the Hydrogel Solution:
1) A solution was prepared containing water, gelatin, PEGdA (polyethylene glycol diacrylate), and photoinitiator IRGACURE-184. To a small glass amber vial, 1.0 g of gelatin (porcine, 300 bloom, barcode 18550) and 10 mL DI water were added. A mixing rod was added to the vial, which was placed on a stir/heat plate at the lowest heat setting until the gelatin went to solution.
2) 500 mg of PEGdA (polyethylene diacrylate 575MW (barcode 18551)) was added to the solution, which was returned to the stir/heat plate to mix under the lowest heat setting.
3) The photoinitiator solution was prepared in a separate vial by adding 0.040 grams or 40 milligrams of DMPA—(2,2 dimethoxy-2-phenylacetophone (barcode 18552)) to 1.0 g of PEGdA and mixing well.
4) 67 microliters of the photoinitiator solution (4) was added to the PEGdA/gelatin mixture in the amber vial (3) and returned to the stir/heat plate to mix under the lowest heat setting.
5) Mixing and heating continued until the solution was dispensed on the tissue (if this solution cools it will congeal and become difficult to pipette).

C. Forming Hydrogel Discs on Tissue:

10, 15, and 20 microliters of the hydrogel solution was dispensed onto the areas of exposed tissue on the tissue-containing plate. The solutions stayed contained to the skin surface and did not wet out onto the Teflon film. The plates were then exposed to UV light using a UV lamp. The samples were polymerized for ˜5 minutes about 30 centimeters away from the lamp. The result was small discs of gelatin -PEGdA interpenetrating network films (hydrogels) adhered directly to a tissue surface in a regularly spaced array. The hydrogel arrays were successfully polymerized in the presence of tissue.

### EXAMPLE 2

### Polymerization and Shaping of Multiple Hydrogels in Contact with Tissue and Bulk and Interfacial (Adhesion) Mechanical Property Measurements

This example describes: 1) the use of molds to shape the hydrogels while polymerizing them directly in contact with tissue; 2) making multiple formulations based on disparate chemistries; and 3) performing bulk and interfacial (adhesion) mechanical property measurements on the resultant hydrogels.

A. Assembly of a Tissue-Containing Mold Plate
1. NEXABAND cyanoacrylate was spread in a thin layer onto two stainless steel flat base plates.
2. Human stratum corneum tissue was adhered to the each plate with the hydrophilic side down on one plate and the hydrophobic side down on the other.
3. A thick TEFLON plate was added to the skin and the assembly was clamped together. The Teflon plate was approximately ¼″ thick and contained nine regularly spaced through-holes in a 3×3 array.

B. Preparation of 2 Hydrogel Solutions
1. A PEGdA/gelatin solution was prepared as in Example 1.
2. nVP/PEGdMA/functional: nVP monomer was mixed with co-monomer (GA) glycidyl acrylate in a 50:50 mixture based on weight percent in an amber bottle. This was added slowly to water and mixed such that it was 74% monomer and 20% water, 2% PEGdMA (PEG dimethacrylate) 600 m.w. crosslinking agent, 2% EtAm (N,N-dimethylamino ethanol) photosensitizer, and 2% I-184 Irgacure photoinitiator.

C. Polymerization
1. The solutions were dispensed into the holes of the Teflon plate having formed wells on the tissue surface. Both hydrogel solutions, above, were dispensed onto each plate (one with the hydrophilic side down and the other with the hydrophobic side down).
2. The samples were cured for 3 minutes under the UV light at a distance of 20 centimeters.
3. After curing, the TEFLON mold was slowly removed, resulting in small hydrogel forms adhering to the tissue surface.

D. Characterization for Mechanical Properties
1. The tissue-containing plate with cured hydrogel samples was tested for both bulk properties and adhesion to tissue using a mechanical analyzer.
2. A probe was lowered onto each sample hydrogel, making contact and adhering to each one using cyanoacrylate adhesive.
3. The probe was pushed into the sample and recorded force, time, and distance information to generate data pertaining to the sample's compressibility.
4. The probe was then made to pull on the sample hydrogel to provide information as to the tensile compliance and force for adhesive failure at the tissue interface.

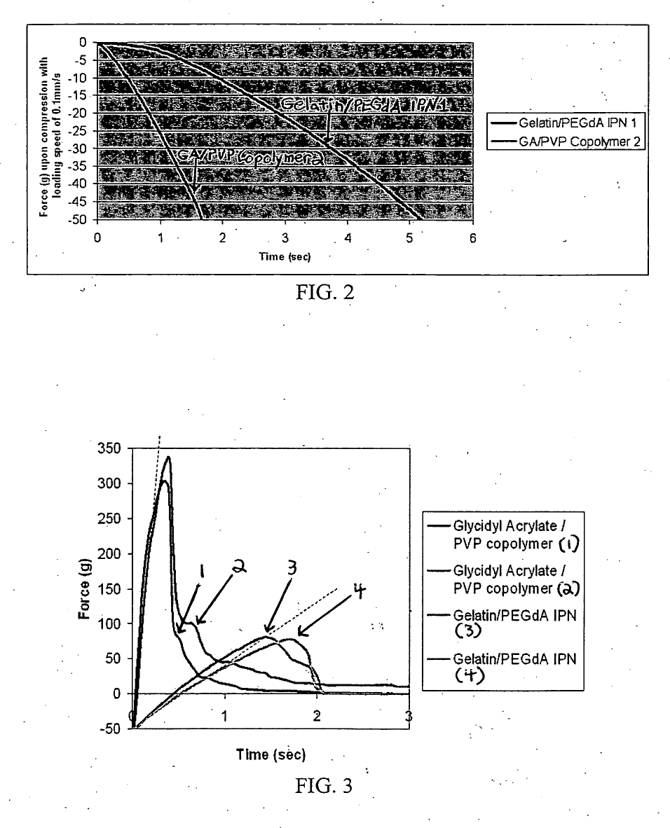

Sample plates and hydrogel arrays were successfully fabricated using the “mold on tissue” approach. 3×3 arrays were fabricated. The hydrogel formulations polymerized directly on the tissue plate. The two hydrogel formulations exhibited disparate mechanical properties due to their compositions, as shown in FIGS. 2 and 3.

### EXAMPLE 3

### Fabrication and Characterization of Hydrozels

This example includes fabrication and characterization of varying compositions of hydrogels on a 96-hydrogel format tissue plate for bond strength, compressibility (bulk property), and equilibrium water content.

A. Assembly of Tissue-Containing Mold Plate
1. NEXABAND cyanoacrylate was spread in a thin layer onto one large (plate-size) stainless steel flat base plate.
2. A large piece of human stratum corneum tissue was adhered to the plate with hydrophilic side down.
3. A thick TEFLON plate was added to the skin and the assembly was clamped together. The TEFLON plate was approximately ⅛″ thick, having 96 regularly spaced through-holes in an 8×12 array with spacing of 9 millimeters on center.
4. The TEFLON plate was clamped to the base plate by using small screws evenly distributed throughout the plate in order to form an array of wells on the tissue surface.

B. Preparation of Stock Solutions

Stock solutions were prepared in order to allow for the combinatorial mixing of a large variety of final formulations.
i. Series 1: Hydrogel solutions were combinatorially dispensed to contain varying ratios of nVP (n-vinyl Pyrrolidone) and GA (glycidyl acrylate) monomers in addition to EtAm (a photosensitizer), PEGdMA (crosslinking agent), NMP (as a solvent), and Irgacure 184 (as a photoinitiator).
ii. Series 2: Hydrogel solutions were combinatorially dispensed to contain varying ratios of nVP (n-vinyl Pyrrolidone) and IE (2-isocyanatoethyl acrylate) monomers in addition to EtAm (a photosensitizer), PEGdMA (crosslinking agent), 1-methyl-2-pyrrolidone (NMP) (as a solvent), and Irgacure 184 (as a photoinitiator).
iii. Series 3: Hydrogel solutions were combinatorially dispensed to contain binary mixtures of the series 1 and series 2 solutions.
iv. Series 4: Hydrogel solutions were combinatorially dispensed to contain varying ratios of gelatin and 700 da. molecular weight PEGdA (polyethylene glycol diacrylate macromer) in addition to deionized water (as a solvent), and DMPA (a photoinitiator)
v. Series 5: Hydrogel solutions were combinatorially dispensed to contain varying ratios of gelatin and 258 da. molecular weight PEGdA (polyethylene glycol diacrylate macromer) in addition to deionized water (as a solvent), and DMPA (a photoinitiator).
vi. Series 6: Hydrogel solutions were combinatorially dispensed to contain varying amounts of initial water diluent for one of the series 4 hydrogels.

C. Polymerization
1. The combinatorially dispensed solutions were transferred into the wells on the tissue surface using a multichannel dispenser.
2. The entire plate was exposed to UV light at ˜20 centimeters from the bulb for ˜4 minutes.

D. Mold Removal and Equilibration
1. The TEFLON mold was removed, leaving the hydrogels adhered to the tissue surface.
2. The plate with tissue and samples was placed in a high humidity chamber (>90%) over night.

E. Characterization for Equilibrium Water Content and Swelling Capacity
1. Before and after equilibration overnight, the plate of tissue and arrayed sample hydrogels were photographed to compare the before and after volume due to any water uptake by the hydrogels.
2. The sample hydrogels were scanned using a profiling laser tool in order to measure the volume change in order to attribute this change to the volume uptake and equilibrium water content after equilibration in the high humidity environment.

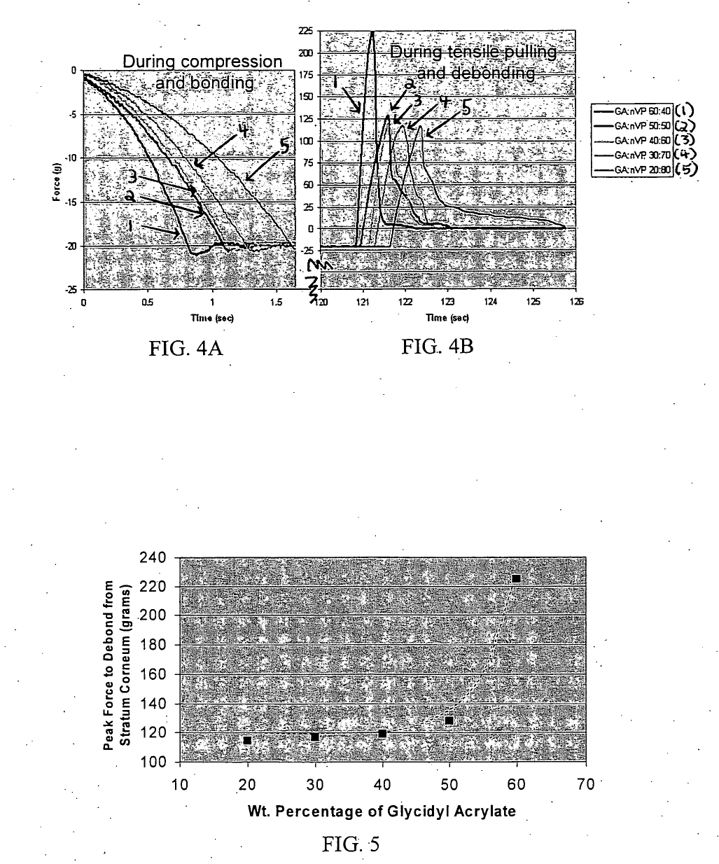

F. Characterization by Mechanical Analysis
1. The plate of tissue and arrayed sample hydrogels were loaded into a mechanical analyzer chamber with controlled humidity.
2. The test probe was centered on the first sample using the automatic stage motion in the x-y plane.
3. The test probe was outfitted with a disposable metal tip coated with cyanoacrylate adhesive.
4. The probe was lowered to the sample hydrogel and allowed to bond for 1 minute under light pressure. Meanwhile, information about the compressibility or compliance of the sample hydrogel was determined by monitoring the strain under applied stress.
5. The probe was then lifted up slowly with a controlled rate.
6. The sample hydrogel first stretched, providing information regarding the tensile compliance of the sample hydrogel, and then failed at the tissue/sample interface in adhesive type failure.
7. The force-time curves were captured for every sample using this approach to yield bulk compliance (or inversely, modulus) and bond strength values (see FIGS. 4A and 4B).
   Results:

Fabrication of 96-Format Arrays of Combinatorially Dispensed Hydrogels:

The fabrication of 96-format plates of hydrogels adhered to tissue was successful.

Mechanical Properties:

The mechanical properties were able to be adjusted in small increments by varying the formulation parameters of the hydrogels. For example, by adjusting the monomer ratio of the nVP and GA containing hydrogel solutions, both the bulk properties of the hydrogel and the adhesive properties to tissue were varied. The graphs in FIGS. 4A and 4B illustrate how these properties can be varied. Note that the mechanical properties of the hydrogels do not change linearly with composition. For example, FIG. 5 shows that adhesive bond strength is a non-linear function of composition. Therefore, such relationships are not readily ascertainable without actually exploring the full formulation space using combinatorial methods.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A method for fabricating combinatorial hydrogel arrays, comprising:
(a) providing hydrogel components;
(b) dispensing said hydrogel components into containers in order to create varying hydrogel chemistries with or without active ingredients;
(c) mixing said hydrogel components to form a hydrogel precursor solution;
(d) providing an array of containers where said hydrogel precursor solutions will be cured or polymerized;
(e) transferring said hydrogel precursor solutions into said array of containers; and
(f) polymerizing or curing said hydrogel precursor solutions in said containers, thereby forming hydrogels.

2. The method of claim 1, further comprising
(a) heating the hydrogel precursor solution;
(b) providing tissue to the correct geometry and physical state; or
(c) removing the containers in preparation for further characterization.

3. The method of claim 2, further comprising affixing said tissue to a planar substrate.

4. A method for testing properties of arrayed hydrogel samples, comprising:
(a) providing an array of hydrogel samples, each of which is held in a container;
(b) exposing said hydrogel samples to a condition; and
(c) collecting and analyzing data obtained from one or more of said samples.

5. The method of claim 4, further comprising separating hydrogel samples of interest from other hydrogel samples.

6. The method of claim 4, wherein said condition is selected from the group consisting of: heat, cold, mechanical perturbation, and contact with a receptor solution.

7. A method for testing the bulk and interfacial mechanical properties of arrayed hydrogel samples, comprising:
(a) contacting a hydrogel sample with a test probe attached to a mechanical tester with a force transducer and load cell;
(b) perturbing said hydrogel sample in tension, compression, or shear mode; and
(c) measuring the resultant force and deflections over time.

8. The method of claim 7, further comprising bonding or mechanically attaching the test probe to said hydrogel sample.

9. A method for assessing the release characteristics of arrayed hydrogels, comprising:
(a) providing an array of hydrogel samples containing active ingredients;
(b) forming an array of receptor wells onto the exposed surface of said hydrogel samples;
(c) dispensing an appropriate receptor solution into the receptor wells;
(d) obtaining samples of the receptor solution in said receptor wells over time; and
(e) analyzing the receptor solution samples to determine the concentration of said active ingredient released from the hydrogel over time.

10. The method of claim 9, further comprising replacing the receptor well solution after step (d).

11. A system for fabricating hydrogels, comprising:
(a) a means for dispensing chemicals;
(b) combinatorial dispensers;
(c) means for mixing, heating, and/or maintaining samples at their processing temperature;
(d) an array of wells or molds;
(e) liquid handling equipment; and
(f) an energy source.

12. The system of claim 11, further comprising tissue preparation tools and fixtures.

13. A system for testing the mechanical bulk and interfacial properties of arrayed hydrogels, comprising:
(a) a mechanical testing instrument that can perturb arrayed hydrogel samples in a controlled fashion and measure the resulting forces and deflections over time;
(b) a test probe that couples the load cell of the testing instrument to the hydrogel sample;
(c) an adhesive dispenser or fixture to apply an adhesive to bond the probe to the hydrogel samples, or to grip the hydrogel sample or to grip a part that has been bonded to the hydrogel sample;
(d) a recording instrument to gather the results and control the sequence of each test; and
(e) an environmental-control chamber that allows for temperature and/or humidity control while the samples are tested.

14. The system of claim 13, further comprising an automated stage to index the plurality of samples into the test position(s).
